(19) United States
(12) Patent Application Publication
(10) Pub. No.: US 2016/0197352 A1
(43) Pub. Date: Jul. 7, 2016

(54) Physiochemical Pretreatment for Battery Current Collector

(71) Applicant: Ford Global Technologies, LLC., Dearborn, MI (US)

(72) Inventors: Rachel BLASER, New Hudson, MI (US); Mohan KARULKAR, Dearborn, MI (US)

(21) Appl. No.: 14/591,497

(22) Filed: Jan. 7, 2015

(51) Int. Cl. H01M 4/66; H01M 4/133; H01M 4/04; H01M 10/0525; H01M 4/1393; H01M 4/1395; H01M 4/62; H01M 4/134

(52) U.S. Cl. CPC H01M 4/667; H01M 4/623; H01M 4/133; H01M 4/134; H01M 4/625; H01M 10/0525; H01M 4/661; H01M 4/1393; H01M 4/1395; H01M 4/0402; H01M 4/0404; H01M 4/364

(57) ABSTRACT

A battery electrode having improved adhesion is disclosed. The electrode may include a copper current collector, a layer of copper hydroxide contacting the copper current collector, a buffer layer contacting the layer of copper hydroxide, the buffer layer including a flexible material and a conductive material, and an electrode active material layer contacting the buffer layer. The electrode active material may be an anode active material including a carbon-silicon composite. The electrode may be formed by chemically treating the current collector to have an increased surface area and then applying a buffer layer to the chemically treated current collector surface and an electrode active material to the buffer layer. The battery electrode may be included in a secondary battery, such as a lithium-ion battery, and may improve electrode active material adhesion and battery capacity.

### TECHNICAL FIELD

The present disclosure relates to physiochemical pretreatments for battery current collectors, for example, for lithium-ion batteries.

### BACKGROUND

Certain secondary battery electrodes experience volume changes during charge and discharge cycles. For example, high-energy electrode materials like silicon (Si) may experience large volume changes during lithiation and delithiation in lithium-ion (Li-ion) batteries. The lateral expansion and contraction of the electrode material may cause delamination from standard current collectors, such as bare copper or aluminum, which may decrease performance and reproducibility. In addition, high-energy electrodes may contain a lower amount of binder, which may hinder initial adhesion to the bare current collector foil, potentially making the problem worse.

### SUMMARY

In at least one embodiment, a battery electrode is provided. The battery electrode may include a copper current collector, a layer of copper hydroxide contacting the copper current collector, a buffer layer contacting the layer of copper hydroxide, the buffer layer including a flexible material and a conductive material, and an electrode active material layer contacting the buffer layer. The flexible material may be a binder material including one or more of carboxymethylcellulose (CMC), poly(vinylidene fluoride) (PVDF) binders, poly(acrylic acid) (PAA), polyacrylonitrile (PAN), polytetrafluoroethylene (PTFE, e.g., Teflon), styrene-butadiene rubber/carboxymethylcellulose (SBR/CMC).

The battery electrode may further include an adhesion layer between the layer of copper hydroxide and the buffer layer including nanofibers of copper hydroxide bonded to the flexible material of the buffer layer. In one embodiment, the buffer layer includes from 90 to 99.9 wt. % flexible material and 0.1 to 10 wt. % conductive material. The conductive material may be graphene. The buffer layer may have a thickness of 10 to 25 μm. The electrode active material may include silicon or a carbon-silicon composite. In one embodiment, the electrode active material includes 70 to 95 wt. % of a carbon-silicon composite, from 1-20 wt. % carbon, and from 1-20 wt. % binder. In another embodiment, the electrode active material includes a binder material that is the same as the flexible material.

In at least one embodiment, a lithium-ion battery is provided. The battery may include a positive and negative electrode, an electrolyte, and a copper current collector. A layer of copper hydroxide may contact the copper current collector and a buffer layer may contact the layer of copper hydroxide, the buffer layer including a flexible material and a conductive material. An electrode active material layer may contact the buffer layer. The flexible material may be a binder material including one or more of carboxymethylcellulose (CMC), poly(vinylidene fluoride) (PVDF) binders, poly(acrylic acid) (PAA), polyacrylonitrile (PAN), polytetrafluoroethylene (PTFE, e.g., Teflon), styrene-butadiene rubber/carboxymethylcellulose (SBR/CMC). In one embodiment, the electrode active material includes 70 to 95 wt. % of a carbon-silicon composite, from 1-20 wt. % carbon, and from 1-20 wt. % binder.

In at least one embodiment, a method of forming a battery electrode is provided. The method may include chemically treating a current collector to increase its surface area, applying a buffer layer to the chemically treated current collector, the buffer layer including a flexible material and a conductive material, and applying an electrode active material to the buffer layer.

The current collector may be a copper current collector and chemically treating the current collector may include applying a first chemical solution to the current collector to form an intermediate surface layer and applying a second chemical solution to the intermediate surface layer to form a second surface layer. In one embodiment, the first chemical solution is NH4OH and the second chemical solution is NaOH. Applying the buffer layer may include applying a layer including 90 to 99.9 wt. % flexible material and 0.1 to 10 wt. % conductive material.

In one embodiment, applying the buffer layer may include casting a slurry onto the chemically treated current collector, the slurry including a solvent with the flexible material dissolved therein. Applying the electrode active material may include casting a slurry onto the buffer layer, the slurry including a solvent with a binder material dissolved therein. In one embodiment, the solvent used to apply the buffer layer is the same as the solvent used to apply the electrode active material. In another embodiment, prior to casting the slurry onto the chemically treated current collector, the slurry may be ultrasonicated at a frequency of 35 to 60 kHz and/or at a temperature of 30° C. to 100° C.

### BRIEF DESCRIPTION OF THE DRAWINGS

FIG. 1 is a schematic of a secondary battery;

FIG. 2 is an image of a bare copper foil current collector (left) and a chemically treated copper foil current collector (right), according to an embodiment;

FIG. 3 is a schematic of a secondary battery including a physical buffer layer, according to an embodiment;

FIG. 4 is a flowchart of the steps in a physiochemical pretreatment process for a current collector, according to an embodiment;

FIG. 5 is a graph of battery capacity vs. number of cycles for batteries having chemical-only, physical-only, and physiochemical pretreatments; and

FIG. 6 is a graph of active material lost during a tack test for batteries having chemical-only, physical-only, and physiochemical pretreatments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

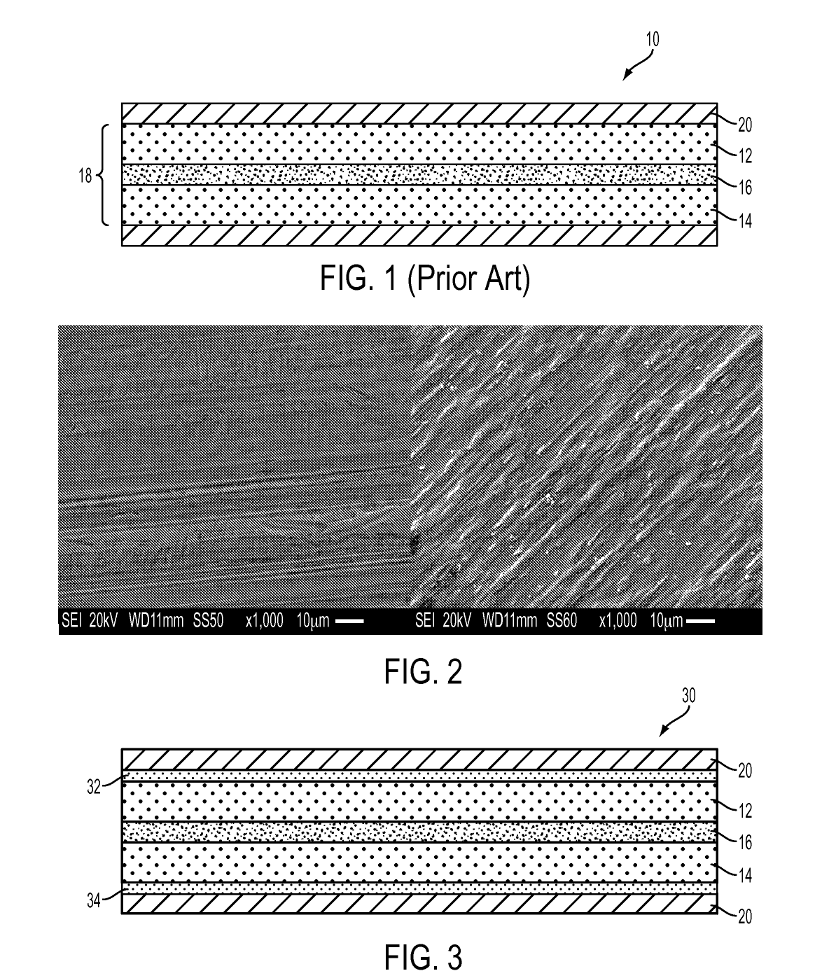

With reference to FIG. 1, a typical battery 10 is shown, which may be a secondary or rechargeable battery (e.g., a lithium-ion battery). The battery 10 includes a negative electrode (anode) 12, a positive electrode (cathode) 14, a separator 16, and an electrolyte 18 disposed within the electrodes 12, 14 and separator 16. However, the battery 10 may include additional components or may not require all the components shown, depending on the battery type or configuration. In addition, a current collector 20 may be disposed on one or both of the anode 12 and cathode 14. In at least one embodiment, the current collector 20 is a metal or metal foil. In one embodiment, the current collector 20 is formed of aluminum or copper. Examples of other suitable metal foils may include, but are not limited to, stainless steel, nickel, gold, or titanium.

Li-ion battery anodes may be formed of carbonaceous materials, such as graphite (natural, artificial, or surface-modified natural), hard carbon, soft carbon, or Si/Sn-enriched graphite. Non-carbonaceous anodes may also be used, such as lithium titanate oxide (LTO), silicon and silicon composites, lithium metal, and nickel oxide (NiO). Li-ion battery cathodes may include lithium nickel cobalt aluminum oxide (NCA), lithium nickel manganese cobalt oxide (NMC), lithium manganese spinel oxide (Mn Spinel or LMO), lithium iron phosphate (LFP) and its derivatives lithium mixed metal phosphate (LFMP), and sulfur or sulfur-based materials (e.g., sulfur-carbon composites). In addition, mixtures of any of two or more of these materials may be used. These electrode materials are merely examples, however, any electrode materials known in the art may be used. Li-ion batteries generally include a liquid electrolyte, which may include a lithium salt and an organic solvent. Examples of lithium salts may include LiPF₆, LiBF₄ or LiClO₄. Suitable organic solvents may include ethylene carbonate (EC), dimethyl carbonate (DMC), ethyl methyl carbonate (EMC), diethyl carbonate (DEC), or mixtures thereof. Li-ion battery separators may be formed of any suitable ionically conductive, electrically insulating material, for example, a polyolefin (e.g., polyethylene or polypropylene).

Electrode production may include casting a slurry onto a current collector 20 and drying the slurry to form an electrode 12 and/or 14. The slurry may include active material, conductive material, binder, and/or solvent. The composite slurry may be spread evenly onto the current collector 20 during casting to facilitate a uniform electrode. If the integrity of the electrode-current collector interface is compromised through repeated cycling and swelling, the interfacial resistance may increase and portions of the active materials may become isolated, leading to capacity fade. Methods for improving the adhesion of the composite electrode to the current collector surface are needed. One of the issues in developing a high performance cell is ensuring a strong and long-lasting bond between the current collector 20 and the composite electrode layer that is applied to it.

Certain electrode materials may present greater challenges in maintaining adhesion between the electrode material and the current collector, both initially and over time. Electrodes containing silicon (Si) may be more susceptible to poor initial adhesion and greater delamination during cycling, compared to more conventional electrode materials. This is due in part to the large volume changes that may occur during lithiation and delithiation in batteries including silicon active materials. For example, pure silicon active materials may experience volume changes of up to 300% or more and silicon composite active materials may experience volume changes of over 50% (e.g., 50-100%).

It has been found that it may be useful to analyze adhesion of the electrode material to the current collector in two time periods: initial adhesion and long-term adhesion. Initial adhesion may be the degree or strength of adhesion when the electrode material, for example a slurry, is applied to the current collector. In contrast, long-term adhesion may be the degree or strength of adhesion during cycling of the battery (e.g., lithiation and delithiation in a Li-ion battery). Adhesion may weaken over time, particularly for electrode materials that experience large volume changes. If the active material separates or delaminates from the current collector, the active material may become isolated and the capacity of the battery may decrease. If the active material progressively delaminates over time, the battery may experience capacity fade.

Accordingly, in at least one embodiment, a method has been discovered for increasing both initial and long-term adhesion of an electrode material to a current collector. The method may include both a chemical pretreatment and a physical pretreatment of the current collector. The combination of chemical and physical treatments is referred to herein as a physiochemical treatment or pretreatment. The physiochemical pretreatment may improve both the initial adhesion of the electrode material and provide improved long-term adhesion during cycling. In one embodiment, the chemical pretreatment may include chemically roughening the surface of the current collector, for example by increasing the surface area, which may primarily improve initial adhesion. In another embodiment, the physical pretreatment may include applying a physical layer or buffering layer between the current collector and the electrode material. The buffer layer may have elastic properties that allow it to absorb, flex, or compensate for large volume changes in the electrode material (e.g., Si-containing electrodes). The buffer layer may therefore primarily improve the long-term adhesion of the electrode material during cycling. While the chemical and physical pretreatments are described as primarily improving initial or long-term adhesion, each pretreatment may also improve the adhesion or other properties during either time period.

In at least one embodiment, a chemical pretreatment may be applied to the anode and/or cathode current collectors. In one embodiment, the current collector is formed of copper, for example a copper foil. A chemical solution may be applied to the copper current collector to increase its surface area. Increasing the surface area of the current collector may provide increased initial adhesion between the current collector and the electrode material by causing increased mechanical interlocking between the two components. The chemical solution may react with the copper current collector to form a new surface layer on the current collector. The new surface layer may include a copper compound and may have an increased surface area compared to the bare copper current collector. A second chemical solution may be applied to the new surface layer and may react with the new surface layer to form a second surface layer. The second surface layer may substantially replace the new surface layer or some of the new surface layer may remain beneath the second surface layer. The second surface layer may also include a copper compound and may have an increased surface area compared to the bare copper current collector.

In one embodiment, the first chemical solution may be an ammonia solution, also known as ammonium hydroxide or NH₄OH. The ammonia solution may react with the copper current collector to form a new surface layer of malachite, a copper carbonate hydroxide mineral with the formula Cu₂CO₃(OH)₂. The ammonia solution may have any concentration sufficient to cause the formation of malachite. In one embodiment, the solution may have a concentration of 1 to 20 M, or any sub-range therein, such as 5 to 15 M, 8 to 12 M, or about 10 M. The ammonia solution may be in contact with the copper current collector for a length of time sufficient to allow the formation of malachite. In one embodiment, the solution may be in contact with the current collector for 1 to 120 minutes, or any sub-range therein, such as 10 to 90 minutes, 15 to 60 minutes, 15 to 45 minutes, or about 30 minutes. In general, the higher the concentration of the solution, the shorter the amount of contact time which may be required, and vice versa. Concentrations and exposure times outside of the above ranges may also be suitable, as long as they cause the formation of malachite. Any volume of the solution may be used that is sufficient to wet the surface of the current collector and to facilitate the reaction with the copper to form malachite.

The second chemical solution may be sodium hydroxide, NaOH. Sodium hydroxide may react with the malachite to form a second surface layer of Cu(OH)₂ (copper(II) hydroxide). The NaOH solution may have any concentration sufficient to cause the formation of Cu(OH)₂. In one embodiment, the solution may have a concentration of 0.5 to 20 M, or any sub-range therein, such as 1 to 15 M, 1 to 10 M, 1 to 5 M, 1 to 3 M, or about 2 M. The NaOH solution may be in contact with the current collector and malachite for a length of time sufficient to allow the formation of Cu(OH)₂. In one embodiment, the solution may be in contact with the current collector for 10 seconds to 30 minutes, or any sub-range therein, such as 10 seconds to 15 minutes, 10 seconds to 5 minutes, 15 seconds to 5 minutes, 30 seconds to 5 minutes, or about 1 minute. In general, the higher the concentration of the solution, the shorter the amount of contact time which may be required, and vice versa. Concentrations and exposure times outside of the above ranges may also be suitable, as long as they cause the formation of Cu(OH)₂. Any volume of the solution may be used that is sufficient to wet the surface of the current collector and malachite to facilitate the reaction with the malachite to form Cu(OH)₂. All or substantially all of the malachite may be converted to Cu(OH)₂ by the sodium hydroxide. The layer of Cu(OH)₂ may have an increased surface area compared to the original, bare copper current collector, which may increase adhesion of the electrode material. In one embodiment, at least a portion of the Cu(OH)₂ may be in the form of nanofibers.

Accordingly, the chemical pretreatment may improve the adhesion of the electrode material by increasing the surface area of the current collector. The increase in surface area may be accomplished without etching or mechanically roughening the surface. Etching and mechanically roughening (e.g., sanding) remove copper and may increase the resistance of the current collector. A comparison of a bare copper current collector foil before and after chemical treatment with ammonia solution and sodium hydroxide is shown in FIG. 2. On the left, the bare copper foil is relatively smooth, while the treated copper foil on the right shows a substantial increase in roughness due to the layer of formed Cu(OH)₂. The treated sample in FIG. 2 was produced by immersing a copper foil current collector in 10 M ammonia solution for 30 minutes, followed by immersing the current collector in 2 M NaOH for 1 minute.

While etching and mechanically roughening may increase the resistance of the current collector, they may still be used in addition to, or in place of, the two-step chemical treatment described above. A copper current collector may be chemically etched to increase the surface area, for example, using nitric acid or ferric chloride, or other etchants known in the art. In addition, while the chemical pretreatment has been described with respect to a copper current collector, a similar pretreatment may be used on other current collector materials, such as aluminum. For example, a chemical treatment may be applied to an aluminum current collector to roughen the surface. Similar to the formation of copper hydroxide, above, the surface may be roughened (e.g., surface area increased) by the formation of a new surface layer comprising an aluminum compound. Alternatively, the surface may be roughened using a suitable chemical etchant or by mechanical methods known in the art.

With reference to FIG. 3, a battery 30 is shown, which includes a negative electrode (anode) 12, a positive electrode (cathode) 14, a separator 16, an electrolyte 18 and current collectors 20, similar to described above with respect to battery 10. These components are described above and will not be described again in detail. In addition to the basic components, however, battery 30 also includes additional buffer layers 32 and 34, which may comprise the physical pretreatment described above. As shown, the buffer layers may be disposed between the current collectors and the electrode active materials. In the embodiment shown in FIG. 3, a buffer layer 32 is located between the anode 12 and its current collector 20 and a buffer layer 34 is located between the cathode 14 and its current collector 20. However, the battery 30 may include only a single buffer layer, which may be either the buffer layer 32 (anode side) or buffer layer 34 (cathode side).

In at least one embodiment, the anode active material may include silicon. For example, the anode active material may include pure silicon or a mixture or composite of carbon and silicon. The carbon may be in any suitable form, such as graphite, carbon black, graphene, carbon nanotubes, or others, or a combination thereof. A binder may also be included. Non-limiting examples of binders known to those of ordinary skill in the art include carboxymethylcellulose (CMC), poly(vinylidene fluoride) (PVDF) binders, poly(acrylic acid) (PAA), polyacrylonitrile (PAN), polytetrafluoroethylene (PTFE, e.g., Teflon), styrene-butadiene rubber/carboxymethylcellulose (SBR/CMC), or others. In one embodiment, the anode active material may include a carbon-silicon composite, carbon, and a binder. The anode active material may include from 70-95 wt. % of the carbon-silicon mixture (e.g., graphite and silicon), or any sub-range therein, such as 75-90 wt. % or 80-85 wt. %. An additional carbon source, such as carbon black, may comprise from 1-20 wt. % of the anode active material, or any sub-range therein. For example, carbon black may comprise 3-15 wt. % or 5-12 wt. % of the anode active material. A binder may form the balance of the final anode active material composition, which may be from 1-20 wt. %, or any sub-range therein. For example, the binder (e.g., PVDF) may comprise 5-15 wt. % or about 10 wt. % of the anode active material.

A carbon-silicon composite may be formed by mixing and heating carbon and silicon powders. In one embodiment, a carbon-silicon composite may be formed by ball milling a solution including carbon and silicon powders and heating the solution. For example, the carbon and silicon powders may be added to a solution of a polymer dissolved in a suitable solvent, such as polyacrylonitrile (PAN) dissolved in NMP. The solution may be ball milled and then annealed, for example at 800° C. for 6 hours. The carbon-silicon composite may then be ball milled again to form a powder with a desired particle size. The final composition of the carbon-silicon composite may include silicon, graphite, and another form of carbon (e.g., PAN-derived C). In one embodiment, the carbon-silicon composite includes 25-50 wt. % Si, 40-60 wt. % graphite, and 10-20 wt. % carbon (e.g., PAN-derived). For example, the composition of the carbon-silicon composite may be 35 wt. % Si, 51 wt. % graphite, and 14 wt. % PAN-derived carbon.

A buffer layer 34 may also be included between the cathode 14 and its current collector 20. As described above, the cathode may include any active material known in the art, such as lithium nickel cobalt aluminum oxide (NCA), lithium nickel manganese cobalt oxide (NMC), lithium manganese spinel oxide (Mn Spinel or LMO), and lithium iron phosphate (LFP) and its derivatives lithium mixed metal phosphate (LFMP), mixtures thereof, or other known materials. In addition, the buffer layer 34 may be helpful in buffering volume changes in more recently developed advanced cathode materials, such as sulfur-based materials.

The buffer layers 32 and 34 may include a resilient, flexible material that is able to elastically expand and contract with the volume changes caused by the charge and discharge cycle (e.g., lithiation and delithiation in silicon-containing electrodes). The flexible material may include any suitable material that is generally inert and non-reactive with the battery components (e.g., electrolyte) and that is able to absorb the changes in volume generated in the electrodes. In one embodiment, the flexible material may be a fluoropolymer, such as PVDF, polytetrafluoroethylene (PTFE), or others. The flexible material may also include known binder materials, such as CMC, CMC/SBR, PAA, or others, such as those disclosed for the anode binder. In one embodiment, the flexible material may include the same material as the binder in the anode and/or cathode. If the flexible material is non-conductive, the buffer layers may also include a conductive material. In one embodiment, the conductive material is a form of carbon, such as graphene, graphite, nanotubes, or carbon black. Other conductive particles may also be used, such as metallic particles (e.g., copper, stainless steel, cobalt, and/or nickel). The conductive material may have a high surface area, for example, 400-800 m²/g.

In embodiments including a conductive material, the relative amount of the conductive material may be adjusted based on the type of electrode. For highly conductive electrodes, such as a carbonaceous anode, less conductive material may be used. If the electrode is less conductive, such as a silicon-carbon anode, more conductive material may be used. In one embodiment, the buffer layers may include from 0.1-10 wt. % conductive material relative to the flexible material, or any sub-range therein. For example, the buffer layer may include 0.1-7.5 wt. %, 0.5-5.0 wt. %, 0.5-2.5 wt. %, 0.5-2.0 wt. %, or about 1.0 wt. % conductive material relative to the flexible material. The buffer layers may include from 90-99.9 wt. % of the flexible material relative to the conductive material, or any sub-range therein. For example, the buffer layer may include 95-99.9 wt. %, 97-99.9 wt. %, 97-99.5 wt. %, 98-99.5 wt. %, or about 99 wt. % of the flexible material relative to the conductive material. In at least one embodiment, the buffer layer may substantially be formed of only the flexible material and the conductive material. In these embodiments, the component not listed in the weight percent ranges above may be considered to be the balance of the composition. For example, if the conductive material forms 0.1-10 wt. % of the buffer layer, then the flexible material forms 90-99.9 wt. %. The disclosed compositions may describe the buffer layer in its final state, after any solvent or other delivery or deposition components have been removed.

In at least one embodiment, the buffer layer may cover or extend over all or substantially all of one or both surfaces of the current collector (e.g., the surfaces that typically contact the active material). If the current collector has been chemically pretreated, for example to produce a layer of copper hydroxide, then the buffer layer may cover or extend over all or substantially all of the chemically treated surface. The buffer layer(s) may have a thickness of 5 to 30 microns, or any sub-range therein. For example, the buffer layer(s) may have a thickness of 5 to 25 μm, 5 to 20 μm, 10 to 25 μm, or 10 to 20 μm, or about 15 μm. The buffer layer may have a thickness that is less than a thickness of the electrode active material, which may generally be from about 50 to 100 μm. A relatively thick buffer layer (e.g., at least 10 μm) may absorb more volume change compared to a relatively thin buffer layer (e.g., 5 μm or less), but may be more difficult to accurately and effectively produce. The slurry processing conditions and control may need to be more accurate to produce a thicker coating. In addition, the selection of the flexible and/or conductive material may be more important to form a thicker film. For example, it has been found that graphene with a surface area of 400-800 m²/g as the conductive material is highly effective at facilitating the formation of a thick (e.g., at least 10 μm) buffer layer.

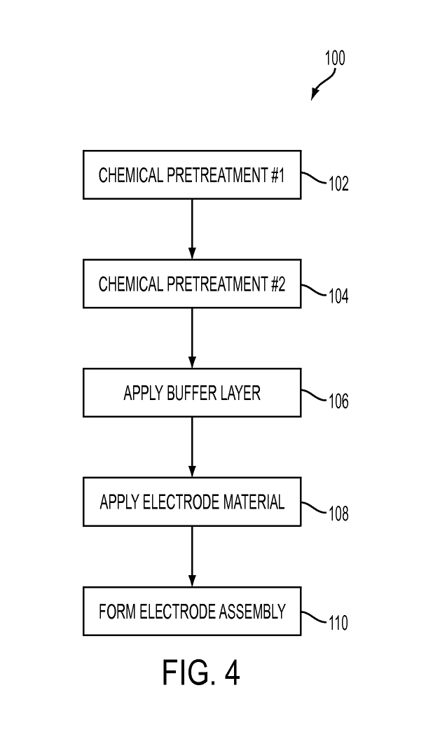

With reference to FIG. 4, a flowchart is shown for a physiochemical pretreatment 100 of a current collector, according to an embodiment. In step 102, a first chemical treatment or pretreatment may be applied to the current collector. As described above, the first chemical pretreatment may include applying an ammonia solution to a copper current collector. The first chemical solution may be applied to one or both sides of the current collector using any suitable application method. Non-limiting examples may include immersing the current collector in the solution, spraying the solution onto the current collector, casting or pouring the solution onto the current collector, or others. The chemical treatment may be performed on a single current collector or it may be a batch process including multiple current collectors. Alternatively, the current collector may be on a roll, and the chemical treatment may be a continuous process.

In step 104, a second chemical treatment or pretreatment may be applied to the current collector. As described above, the first chemical treatment may react with the current collector to form a new surface layer. For example, ammonia solution in the first treatment may have reacted with the copper to form malachite on the treated surfaces. In the second chemical treatment, a second chemical solution may be applied to the same surfaces treated in step 102 (e.g., one or both of the sides). As described above, the second chemical may include sodium hydroxide (NaOH), which may react with malachite to form Cu(OH)₂. The second chemical solution may be applied to the current collector using the same or similar methods as step 102, such as immersion, spraying, pouring, etc. The second treatment step may also be a single, batch, or continuous process. If a different chemical is used for the chemical pretreatment, there may be only a single step or there may be multiple steps (e.g., 2, 3, or more) to form a new surface layer having increased surface area.

In step 106, a buffer layer may be applied or deposited onto the chemically treated surface of the current collector (e.g., copper or aluminum). The buffer layer may include a flexible and/or resilient material and a conductive material, such as PVDF and graphene, respectively. The buffer layer may be applied as a slurry, which may include the flexible material, the conductive material, and a solvent. Any solvent suitable for the flexible material may be used. For example, a dipolar aprotic solvent may be used for a PVDF flexible material, such as n-methyl-2-pyrrolidone (NMP), dimethylformamide, or dimethyl sulfoxide. However, any solvent that is appropriate for the flexible material may be used. For example, if the flexible material is CMC, then water may be used as a solvent. Another suitable solvent may include acetone.

The buffer layer slurry may be ultrasonicated prior to application on the current collector. The slurry may be ultrasonicated for a time suitable to homogeneously distribute the conductive material (e.g., graphene) within the slurry. For example, the slurry may be ultrasonicated for 1 minute to 5 hours, or any sub-range therein, such as 15 minutes to 3 hours, 30 minutes to 2 hours, or for about 1 hour. If the conductive material has a layered structure, such as graphene, the ultrasonication may be performed at a frequency that promotes exfoliation of the layers (e.g., separation). It has been discovered that a frequency of 35 to 60 kHz, or any sub-range therein, may promote exfoliation of graphene. For example, the ultrasonication may be performed at a frequency of 40 to 50 kHz or about 43 kHz. The exfoliated conductive material, such as graphene, may therefore have a higher surface area, resulting in improved conductivity.

In addition to frequency, it has been discovered that the temperature of the slurry during ultrasonication may affect the properties of the buffer layer. Without being held to any particular theory, it is believed that increasing the temperature of the slurry may cause a structural change in the flexible material. For example, when PVDF is ultrasonicated at room temperature and cast, it has a translucent appearance. However, PVDF ultrasonicated at an elevated temperature (e.g., 70° C.) and cast has an opaque appearance. In some cases, it has been found that without elevating temperature of the slurry, the disclosed benefits of the buffer layer are significantly reduced. Accordingly, in at least one embodiment, the temperature of the slurry may be increased, relative to room or ambient temperature (e.g., about 20° C.), during ultrasonication. However, temperatures above a certain level (e.g., 100° C.) may damage the graphene or otherwise reduce its effectiveness. For example, the slurry may have a temperature of at least 30° C. during ultrasonication, such as 30° C. to 100° C., 50° C. to 100° C., 60° C. to 80° C., or about 70° C. (e.g., ±5° C.).

The slurry may be cast onto the chemically treated current collector and the solvent may be evaporated to leave a buffer layer, as described above. In one embodiment, the flexible material of the buffer layer may be the same as the binder material of at least one of the electrodes, such as the anode active material. In another embodiment, the same solvent may be used to apply or deposit the buffer layer and one or both of the electrode materials (e.g., NMP or water). When the buffer layer is applied to the chemically pretreated copper foil, an adhesion layer may be formed between the layer of copper hydroxide and the buffer layer. The adhesion layer may include nanofibers of copper hydroxide bonded to the flexible material of the buffer layer, for example, by Van der Waals forces.

In step 108, the electrode material may be applied or deposited onto the buffer layer. The electrode material may be an anode active material or cathode active material. As described above, the anode active material may include silicon, such as a carbon-silicon composite. The anode active material may also include a binder, such as PVDF. The anode active material may be applied as a slurry using a suitable solvent, similar to the buffer layer. Any solvent suitable for the active material components may be used. For example, a dipolar aprotic solvent, such as n-methyl-2-pyrrolidone (NMP), dimethylformamide, or dimethyl sulfoxide. However, any solvent that is appropriate for the binder material may be used. For example, if the binder material is CMC, then water may be used as a solvent. Another example of a suitable solvent may include acetone. The slurry may be cast onto the buffer layer and the solvent may be evaporated to leave an electrode layer, such as those described above. As described above, the binder material and/or the solvent used in step 108 may be the same as the flexible material and/or solvent used in step 106. If the same solvent is used to apply the electrode material as is used to apply the buffer layer (or if both solvents that are used dissolve the flexible material and the binder), a top surface of the buffer layer may be re-dissolved during the application of the electrode material. This may ensure that the two layers become tightly or intimately bonded to one another at an interface between the buffer layer and the electrode material.

Steps 102 to 108 may be applied to either or both of the anode and cathode. Accordingly, if both electrodes are to be given the physiochemical pretreatment, steps 102-108 may be performed on each. If only one of the electrodes is pretreated, the other electrode may be formed using methods and techniques known to those of ordinary skill in the art. At step 110, the electrodes may be formed into an electrode assembly or stack. If still in a continuous roll or coil, the electrodes may be cut or stamped to form individual electrode sheets. The electrodes may then be assembled by stacking and pressing an anode, separator, and cathode, such as shown in FIG. 3. While FIG. 3 shows a stack having a single anode, separator, and cathode, one of ordinary skill in the art will understand that the stack may include a plurality of each component.

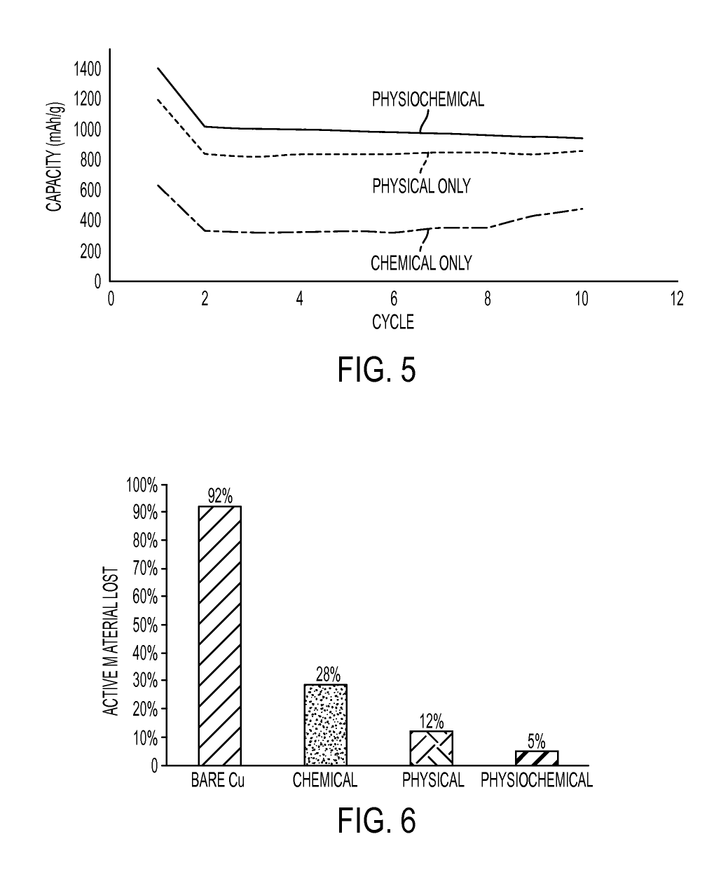

With reference to FIGS. 5 and 6, experimental data confirms that the disclosed physiochemical pretreatment is effective at increasing capacity and adhesion of electrode active materials to the current collectors. FIG. 5 shows a graph of capacity as a function of cycle time for carbon-silicon electrodes that received a chemical-only pretreatment, buffer layer-only pretreatment, and the disclosed physiochemical pretreatment. The electrodes where cycled at 1.0 mA/cm² with a potential window of 0.02V-1.2V. As shown in FIG. 5, the electrode that received the physiochemical pretreatment significantly outperformed both the chemical-only and buffer-only pretreatments. This demonstrates that a combination of the two treatments has a synergistic effect by addressing both initial adhesion (chemical treatment) and delamination over time (physical buffer).

The anode layers for all three samples were prepared as follows. The C—Si composite anode material was synthesized from 28 wt % Si (Alfa Aesar, 325 mesh), 42 wt % graphite (Aldrich, <20 micron), and 30 wt % polyacrylonitrile (PAN). 0.6 g PAN was dissolved in 10 ml Nmethylpyrrolidinone (NMP) by stirring for approximately 6 hours at 50° C. The solution was then combined with graphite and silicon powder and ball milled for 16 hours using a multiple sample adapter holder (SPEX 8000M mixer/mill). After milling, the solution was annealed in a tube reactor furnace in order to pyrolize the PAN and form the C—Si composite material. Samples were annealed at 800° C. for 6 hours using a heating rate of 2° C./min and an Ar flow of 140 cc/min. After annealing, the C—Si material was ball milled for 10 additional minutes. Accounting for mass loss during annealing, final composition was 35% Si, 51% milled graphite, and 14% PAN-derived C. Electrodes were prepared by tape casting onto a Cu foil current collector. Slurries were prepared by combining 82 wt % C—Si powder, 8 wt % C45 carbon black (TIMCAL), and 10 wt % PVDF (Kynar PowerFlex) in NMP (4:1 NMP:solids) for 1 hour at 50° C. Slurries were then tape cast with a blade height of 0.3 nun and dried under vacuum at 120° C. for 12 hours. After drying, the electrode was cooled at room temperature for at least 2 hours before use.

The buffer layers in the buffer-only and the physiochemical pretreatment were prepared as follows. The conductive layer slurry was 1 wt % graphene (6-8 nm, SkySpring Nanomaterials Inc.) and 99% PVDF in NMP. The NMP:solids weight ratio was 10:1, which facilitated a very thin film after drying. The conductive layer slurry was ultrasonicated (L&R Quantex Ultrasonics, 360H) for 1 hour at about 70° C. and 43 kHZ to exfoliate and distribute the graphene and make a homogenous slurry. After ultrasonication, the conductive layer slurry was cast on Cu foil using a doctor blade set to 0.15 mm, and then dried under vacuum at 120° C. for 30 minutes to produce a buffer layer with a thickness of 13 μm. A layer of C—Si slurry was then immediately cast on top of the conductive layer, and the electrode was dried under vacuum at 120° C. for 12 hours.

The chemical pretreatment in the chemical-only and the physiochemical pretreatment was performed as follows. A 10 M solution of NH₄OH was added to a Kimble dish and the copper foil was immersed in the solution such that the whole foil was submerged. The foil was allowed to soak for 30 minutes, after which it was removed and rinsed with DI water. A 2 M solution of NaOH was added to another Kimble dish and the copper foil was immersed in the solution such that the whole foil was submerged. The foil was allowed to soak for 1 minute, after which it was removed and rinsed with DI water.

A capacity of 1200 mAh/g has been achieved with the disclosed dual-cast physiochemical pretreatment. This capacity is within 1% of the theoretical maximum for the disclosed Si—C composite anode. The disclosed dual-cast physiochemical pretreatment may be applied to other electrode active materials, which may have higher theoretical maximums. Accordingly, the disclosed dual-cast pretreatment may facilitate even higher capacities by allowing current and future electrode materials to reach or approach their theoretical maximum capacities.

FIG. 6, which shows the results of a tack test, also confirms the superior impact of applying both a chemical and physical pretreatment. The samples tested in FIG. 6 were prepared the same way as described for the samples in FIG. 5. Electrodes were adhered to a glass slide with nitrocellulose cement and allowed to dry for 12 hours. A strip of clear tape was cut and weighed, and then placed over the electrode. Another glass slide was placed on top of the electrode and tape, and a 538 g weight was then set on top of the glass slide. After 10 seconds, the weight was removed along with the top glass slide. The clear tape was then peeled off the electrode and re-weighed to determine the amount of material removed. As shown, the bare copper electrode had very poor adhesion, with 92% of the active material lost during the tack test. The chemical-only electrode had better adhesion at 28% and the physical-only electrode did better still at 12%. However, the electrode that received the disclosed physiochemical pretreatment showed significantly better adhesion than both the chemical-only and physical-only electrodes, with only 5% active material lost.

Accordingly, it has been discovered that a combination of a chemical pretreatment and a physical buffer pretreatment (physiochemical pretreatment) significantly improves the adhesion and capacity of electrode active materials. The physiochemical pretreatment provides greatly enhanced adhesion for electrode active materials that experience high volume change during charge/discharge cycles, such as silicon-based anode materials. The discovered method reveals that a two-pronged approach improves adhesion and reduces capacity fade. A chemical pretreatment improves initial adhesion by increasing the surface area of the current collector foil. A physical buffer layer applied to the chemically roughened current collector improves long-term adhesion by absorbing or flexing with the volume changes that occur during lithiation/delithiation cycles. Surprisingly, the two-pronged approach is not redundant, but instead provides substantially better capacity and adhesion compared to either treatment done alone (as shown in FIGS. 5-6). Conventionally, adding additional material between the electrode active material and the current collector has been disfavored due to, for example, concerns of increased impedance. However, the disclosed dual-cast physiochemical pretreatment has surprisingly not resulted in increased impedance, but has improved the performance of the battery.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery electrode comprising:
a copper current collector;
a layer of copper hydroxide contacting the copper current collector;
a buffer layer contacting the layer of copper hydroxide, the buffer layer including a flexible material and a conductive material; and
an electrode active material layer contacting the buffer layer.

2. The battery electrode of claim 1, wherein the flexible material is a binder material including one or more of carboxymethylcellulose (CMC), poly(vinylidene fluoride) (PVDF) binders, poly(acrylic acid) (PAA), polyacrylonitrile (PAN), polytetrafluoroethylene (PTFE, e.g., Teflon), styrene-butadiene rubber/carboxymethylcellulose (SBR/CMC).

3. The battery electrode of claim 1 further comprising an adhesion layer between the layer of copper hydroxide and the buffer layer including nanofibers of copper hydroxide bonded to the flexible material of the buffer layer.

4. The battery electrode of claim 1, wherein the buffer layer includes from 90 to 99.9 wt. % flexible material and 0.1 to 10 wt. % conductive material.

5. The battery electrode of claim 1, wherein the buffer layer has a thickness of 10 to 25 μm.

6. The battery electrode of claim 1, wherein the electrode active material includes silicon.

7. The battery electrode of claim 1, wherein the electrode active material includes a carbon-silicon composite.

8. The battery electrode of claim 1, wherein the electrode active material includes 70 to 95 wt. % of a carbon-silicon composite, from 1-20 wt. % carbon, and from 1-20 wt. % binder.

9. The battery electrode of claim 1, wherein the electrode active material includes a binder material that is the same as the flexible material.

10. The battery electrode of claim 1, wherein the conductive material is graphene.

11. A lithium-ion battery comprising:
a positive and negative electrode;
an electrolyte;
a copper current collector;
a layer of copper hydroxide contacting the copper current collector;
a buffer layer contacting the layer of copper hydroxide, the buffer layer including a flexible material and a conductive material; and
an electrode active material layer contacting the buffer layer.

12. The battery of claim 11, wherein the electrode active material includes 70 to 95 wt. % of a carbon-silicon composite, from 1-20 wt. % carbon, and from 1-20 wt. % binder.

13. The battery of claim 11, wherein the flexible material is a binder material including one or more of carboxymethylcellulose (CMC), poly(vinylidene fluoride) (PVDF) binders, poly(acrylic acid) (PAA), polyacrylonitrile (PAN), polytetrafluoroethylene (PTFE, e.g., Teflon), styrene-butadiene rubber/carboxymethylcellulose (SBR/CMC).

14. A method of forming a battery electrode, comprising:
chemically treating a current collector to increase its surface area;
applying a buffer layer to the chemically treated current collector, the buffer layer including a flexible material and a conductive material; and
applying an electrode active material to the buffer layer.

15. The method of claim 14, wherein the current collector is a copper current collector and chemically treating the current collector includes applying a first chemical solution to the current collector to form an intermediate surface layer and applying a second chemical solution to the intermediate surface layer to form a second surface layer.

16. The method of claim 15, wherein the first chemical solution is NH₄OH and the second chemical solution is NaOH.

17. The method of claim 14, wherein applying the buffer layer includes applying a layer including 90 to 99.9 wt. % flexible material and 0.1 to 10 wt. % conductive material.

18. The method of claim 14, wherein applying the buffer layer includes casting a slurry onto the chemically treated current collector, the slurry including a solvent with the flexible material dissolved therein.

19. The method of claim 18, wherein prior to casting the slurry onto the chemically treated current collector, the slurry is ultrasonicated at a frequency of 35 to 60 kHz and a temperature of 30° C. to 100° C.

20. The method of claim 18, wherein applying the electrode active material includes casting a slurry onto the buffer layer, the slurry including a solvent with a binder material dissolved therein, and the solvent used to apply the buffer layer is the same as the solvent used to apply the electrode active material.
